(19) United States
(12) Patent Application Publication
(10) Pub. No.: US 2026/0268434 A1
(43) Pub. Date: Sep. 10, 2026

(54) DATA PROCESSING METHOD AND DATA PROCESSING PROGRAM

(71) Applicant: Nomura Research Institute, Ltd., Tokyo (JP)

(72) Inventors: Kohei Doihara, Tokyo (JP); Gouichirou Kunou, Tokyo (JP); Hiroki Tsuboi, Tokyo (JP)

(21) Appl. No.: 19/288,371

(22) Filed: Aug. 1, 2025

(30) Foreign Application Priority Data
Mar. 6, 2025 (JP) 2025-035670

(51) Int. Cl. G06T 1/20

(52) U.S. Cl. CPC G06T 1/20

(57) ABSTRACT

A data processing method for processing a data in a data frame format by a computer including a GPU, causing the computer to execute a first step of reading all or a part of a data to be processed and loading the data into a data frame on a memory of the GPU; a second step of merging a second data which is necessary for processing a first data loaded in the data frame into the data frame; a third step of determining whether a condition for executing a predetermined process is satisfied for each column of the data frame; and a fourth step of extracting a row in which a value of each column satisfies the condition in the data frame, executing the predetermined process on each row, which has been extracted, through parallel processing of the GPU, and recording a processing result in the each row.

### BACKGROUND OF THE INVENTION

### 1. Technical Field

The present invention relates to a technology of data processing in a computer, and particularly relates to a technology which can be effectively applied to a data processing method and a data processing program for performing data processing by a graphics processing unit (GPU).

### 2. Description of the Related Art

In recent years, in fields requiring enormous computation processing, such as mining in blockchain technology, development of generative artificial intelligence (AI), machine learning, and simulation, general-purpose computing on GPU (GPGPU) using a GPU has become increasingly widespread (see, for example, “Acceleration by GPGPU”, [online], Parallel and Embedded Architecture Research Laboratory, Division of Engineering and Agriculture, Graduate School of Regional Development and Creativity, Utsunomiya University, [searched on Feb. 13, 2025], Internet<URL:http://www.is.utsunomiya-u.ac.jp/pearlab/ja/18/gpu/>), and has demonstrated significant results in computation-intensive fields that are difficult to handle with a central processing unit (CPU).

Examples of a technology for using a GPU for general-purpose calculation applications other than original image processing include a general-purpose parallel computing platform and programming model for GPUs developed and provided by NVIDIA (registered trademark) Corporation, namely compute unified device architecture (CUDA) (“CUDA Toolkit—Free Tools and Training |NVIDIA Developer”, [online], NVIDIA Corporation, [searched on Jan. 30, 2025], Internet<URL:https://developer.nvidia.com/cuda-toolkit>) (registered trademark, the same applies hereinafter).

### SUMMARY OF THE INVENTION

In an existing backbone system (so-called “legacy system”) constructed by a mainframe or the like, there is a problem in coping with, for example, lack of maintenance support of operating hardware and software, and migration such as changing a use language of an application may be performed when the system is renewed. In a legacy system, enormous data processing such as batch processing is performed, and it is also important to increase the speed of the data processing in migration.

Since the batch processing of the mainframe is data aggregation processing, it is expected to increase the speed by applying CUDA or the like at the time of migration to perform GPU processing.

As described in “Acceleration by GPGPU” and the like, in the GPU processing, since parallel computation can be performed by a large number of computation cores, the GPU processing is suitable for collectively processing the same computation in a large amount. However, in a program in which the content of processing or computation changes depending on the content of data or conditions, such as a program including branch processing, the processing performance may be extremely degraded, and the speed may fail to be increased. In a program such as batch processing of a legacy system, since parallel processing by a GPU or the like is not assumed, there may be branch processing in which the processing performance is degraded, and there is a problem of achieving high speed.

Therefore, an object of the present invention is to provide a data processing method and a data processing program for processing and reconstructing a necessary data group into a form capable of performing batch calculation in parallel when a large amount of computation is performed on a GPU. The above-mentioned and other objects and novel features of the present invention will become apparent from the description herein and the accompanying drawings.

A representative embodiment of the invention disclosed in the present application will be briefly outlined as follows.

A data processing method, as a representative embodiment of the present invention, is for processing a data in a data frame format by a computer including a GPU, and causes the computer to execute a first step of reading all or a part of a data to be processed and loading the data into a data frame on a memory of the GPU; a second step of merging a second data which is necessary for processing a first data loaded in the data frame into the data frame; a third step of determining whether a condition for executing a predetermined process is satisfied for each column of the data frame; and a fourth step of extracting a row in which a value of each column satisfies the condition in the data frame, executing the predetermined process on each row, which has been extracted, through parallel processing of the GPU, and recording a processing result in the each row.

The representative embodiment of the present invention can also be applied to a data processing program that causes a computer to execute the above-described data processing method.

An effect obtained by the representative embodiment of the invention disclosed in the present application will be briefly described as follows. That is, according to the representative embodiment of the present invention, when a large amount of computation is performed on the GPU, it is possible to process and reconstruct a necessary data group into a form capable of performing batch calculation in parallel.

### BRIEF DESCRIPTION OF THE DRAWINGS

FIG. 1 is a diagram illustrating an outline of an example of a data processing method according to one embodiment of the present invention;

FIG. 2 is a diagram illustrating an outline of an example of current data frame processing;

FIG. 3 is a diagram illustrating an outline of an example of data frame processing according to one embodiment of the present invention;

FIG. 4 is a diagram illustrating an outline of an example of current IF branch processing;

FIG. 5 is a diagram illustrating an outline of an example of IF branch processing according to one embodiment of the present invention;

FIG. 6 is a diagram illustrating an outline of an example of specific calculation processing according to one embodiment of the present invention;

FIG. 7 is a diagram illustrating an outline of another example of data frame processing according to one embodiment of the present invention;

FIG. 8 is a diagram illustrating an outline of another example of data frame processing according to one embodiment of the present invention;

FIG. 9 is a diagram illustrating an outline of another example of data frame processing according to one embodiment of the present invention; and

FIG. 10 is a diagram illustrating an outline of another example of data frame processing according to one embodiment of the present invention.

### DETAILED DESCRIPTION

Hereinafter, embodiments of the present invention will be described in detail with reference to the accompanying drawings. In all the drawings for explaining the embodiments, the same parts are denoted by the same reference numerals in principle, and duplicated descriptions thereof will be omitted. Meanwhile, a constituent part denoted by a reference sign in the description with reference to one drawing may be mentioned with the same reference sign denoted in the description with reference to other drawings in which the constituent part is not illustrated again.

### Outline

In recent data processing, there are many cases where flexible and efficient processing is performed by using a data frame (data in a table format consisting of rows and columns), and the above-described CUDA also provides a cuDF (cuda based DataFrames, https://github.com/rapidsai/cudf) which is a library for performing data frame processing on a GPU. A data processing method according to one embodiment of the present invention also achieves high speed by performing calculation processing in batch processing or the like by data frame processing on a GPU.

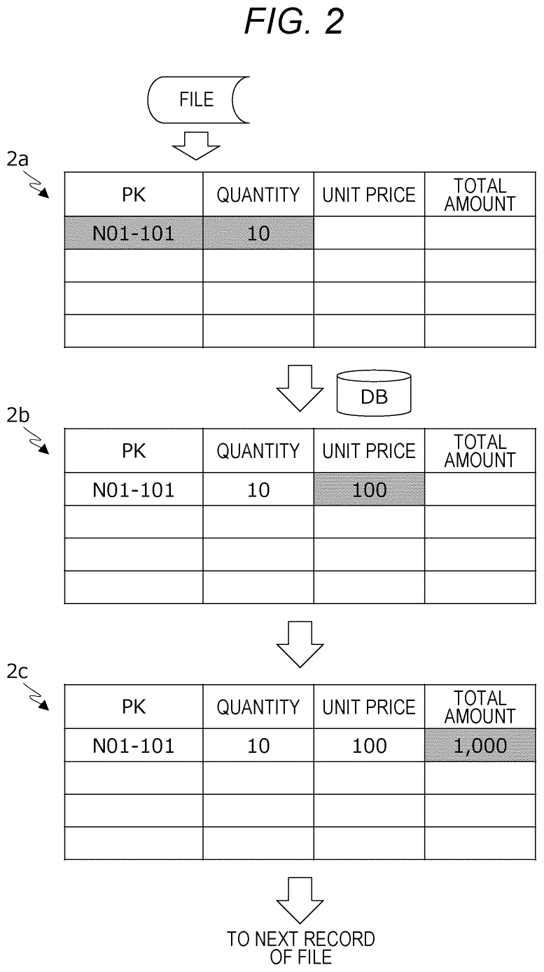

FIG. 2 is a diagram illustrating an outline of an example of current data frame processing. Here, a simple example is illustrated in which a total amount is calculated by multiplying a quantity data by a predetermined unit price. In the current processing, processing of reading a quantity of records one by one from a file, acquiring information of a unit price for the records, and multiplying the quantity by the unit price to calculate a total amount is repeated for the number of records in the file.

That is, as illustrated in the example of FIG. 2, first, data (a quantity in the example of FIG. 2) of a record identified by a primary key (PK) is read one by one from a file and is loaded into a data frame (data frame 2a). Then, the information on the corresponding unit price is acquired from a database (DB) or the like and recorded in the data frame (data frame 2b), and the total amount obtained by multiplying the quantity by the unit price is recorded in a data frame (data frame 2c). This is loop processing in which the above processing is repeated for the number of records in the file.

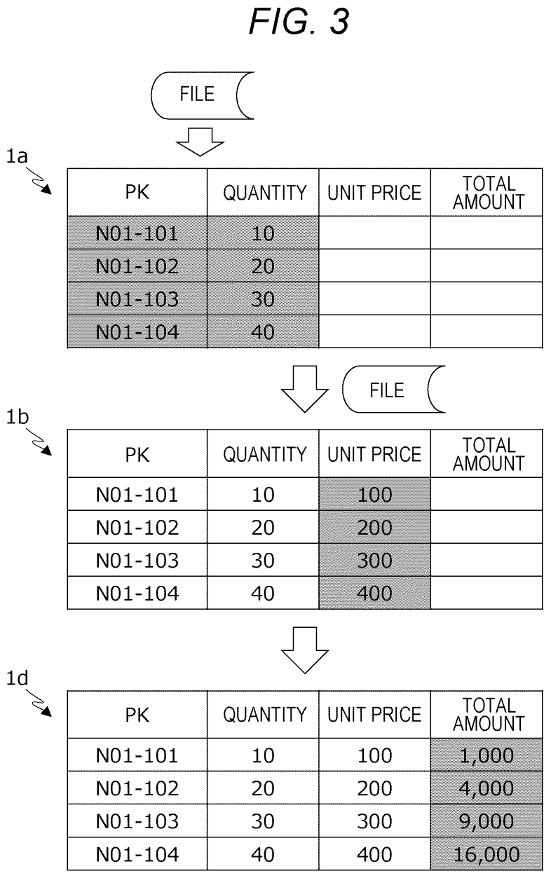

FIG. 3 is a diagram illustrating an outline of an example of data frame processing according to one embodiment of the present invention. Here, in an example similar to that of FIG. 2 described above, the example in which the data frame processing is performed on the GPU is illustrated, wherein the entire file (or a chunk of a predetermined size) is read to merge information of a necessary unit price, and then calculation processing is performed in parallel by the GPU for a plurality of records.

That is, as illustrated in the example of FIG. 3, first, the entire file (PK and quantity) is read and loaded into a data frame (data frame 1a). Then, the information of the necessary unit price is acquired from the file or the like, the acquired information is merged into a data frame (data frame 1b), and the total amount which is a target value for the plurality of records is collectively calculated through parallel processing by the GPU (data frame 1d).

As described above, the calculation processing for the data frame is not a current row-oriented processing as illustrated in the example of FIG. 2, but a column-oriented processing as illustrated in the example of FIG. 3, and thus, it is possible to increase the speed through parallel calculation processing by the GPU.

### IF Branch Processing

As a typical syntax of the branch processing, there is an IF branch in which a process of YY is performed when a condition of XX is satisfied (or not satisfied).

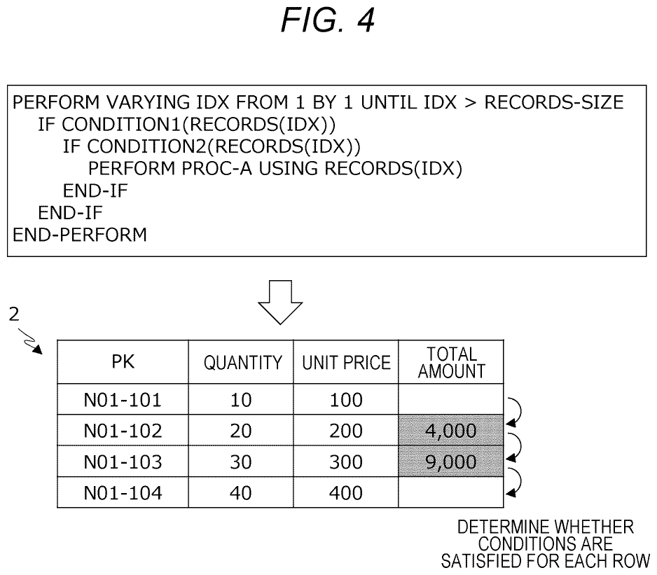

FIG. 4 is a diagram illustrating an outline of an example of current IF branch processing. The upper part of the drawing illustrates an example of a COBOL program having contents branched by an IF statement, and the lower part of the drawing illustrates a data frame 2 similar to the example of FIG. 2 described above. In the current processing, each record (row) of the data frame 2 is sequentially checked to determine whether it satisfies the conditions of the IF statement (“CONDITION1”, “CONDITION2”), and a predetermined process (“PROC-A”) is executed using the value of the record (“RECORDS(IDX)”) only when each condition is satisfied, and this processing is repeated for each record of the data frame 2. The example of the data frame 2 in FIG. 4 indicates that the total amount is calculated from the quantity and the unit price as the predetermined process assuming that the PK satisfies the conditions in two records of “N01-102” and “N01-103”.

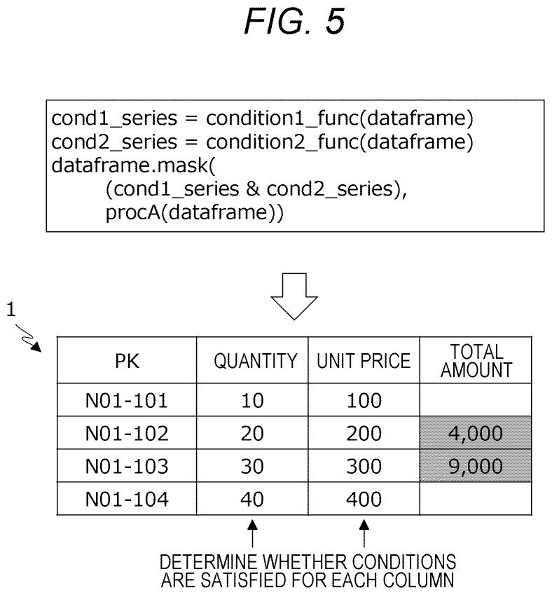

FIG. 5 is a diagram illustrating an outline of an example of IF branch processing according to one embodiment of the present invention. The upper part of the drawing illustrates an example of a Python (registered trademark, the same applies hereinafter) program using a cuDF library of contents to be processed in a case where the conditions are satisfied, and the lower part of the drawing illustrates a data frame 1 similar to the example of FIG. 3 described above. In the present embodiment, whether the conditions are satisfied is checked for each column of the data frame 1 (“condition1_func”, “condition2_func”), only rows that satisfy the conditions (true for both “cond1_series” and “cond2_series”) are filtered, and a predetermined process (“procA”) is collectively performed through parallel processing by the GPU. The example of the data frame 1 in FIG. 5 indicates that the total amount is calculated from the quantity and the unit price as the predetermined process collectively for these records assuming that the PK satisfies the conditions in two records of “N01-102” and “N01-103”.

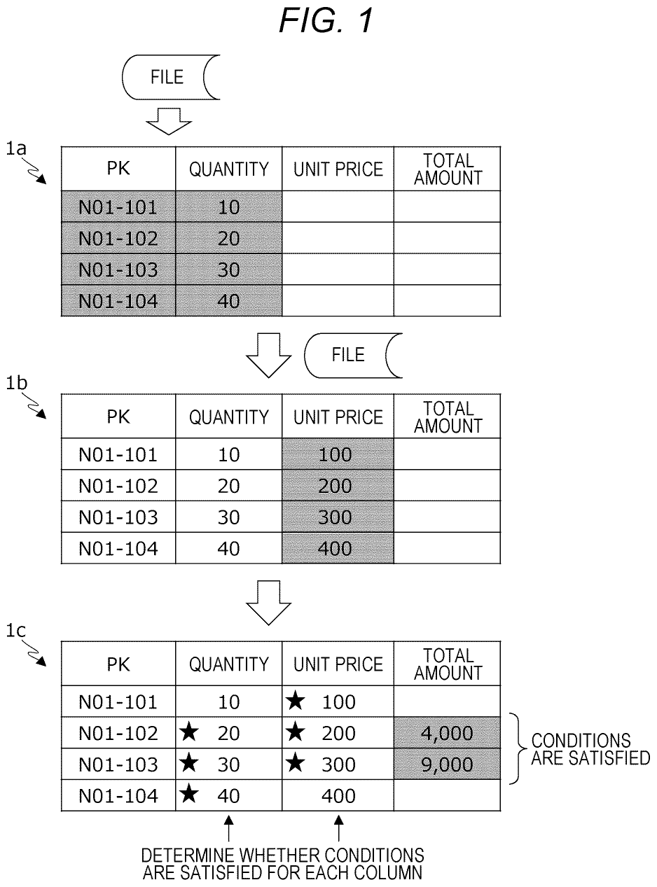

FIG. 1 is a diagram illustrating an outline of an example of a data processing method according to one embodiment of the present invention. Here, an example of more specific data frame processing related to the IF branch processing illustrated in the above-described example of FIG. 5 is illustrated. Similarly to the example of FIG. 3 described above, first, the entire file (PK and quantity) is read and loaded into a data frame (data frame 1a). Then, the information of the necessary unit price is acquired from the file or the like, and merged into a data frame (data frame 1b), whether the conditions are satisfied for each column is determined, and the total amount which is the target value is collectively calculated for only the rows which satisfy the conditions through parallel processing by the GPU (data frame 1c).

In FIG. 1, an example is illustrated in which the rows satisfying the condition for quantity are the three records with primary keys “N01-102”, “N01-103”, and “N01-104” (indicated by stars in a quantity column in the drawing), and the rows satisfying the condition for unit price are the three records with primary keys “N01-101”, “N01-102”, and “N01-103” (indicated by stars in the unit price column in the drawing). In this case, it is indicated that the total amount which is the target value is collectively calculated through parallel processing by the GPU only for the records of “N01-102” and “N01-103” satisfying the conditions in the two columns and the result is set to be in a total amount column.

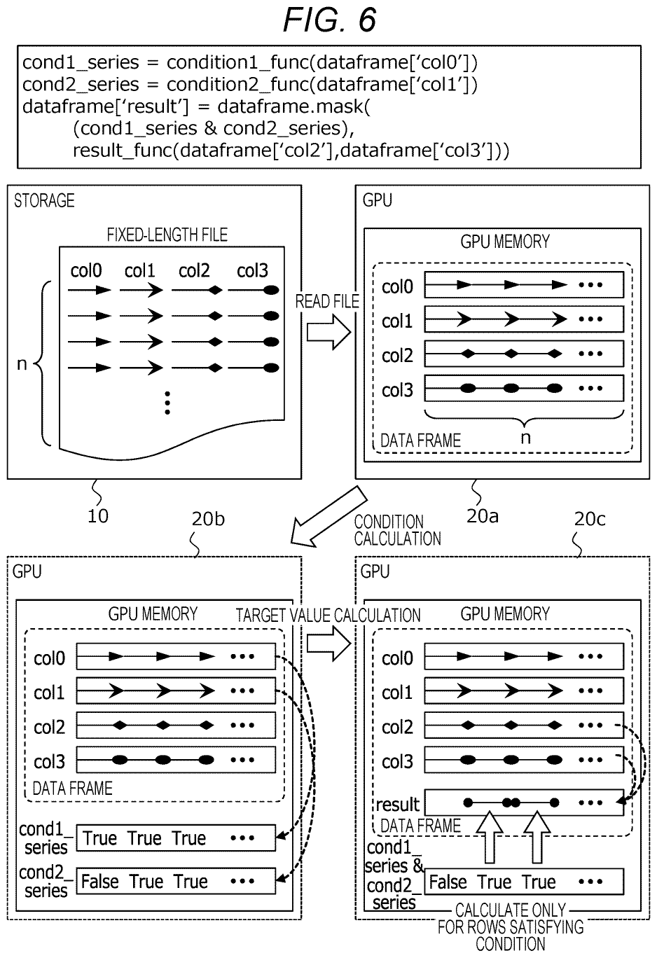

FIG. 6 is a diagram illustrating an outline of an example of specific calculation processing according to one embodiment of the present invention. Here, an example is illustrated in which the target value is calculated on the basis of the value of a predetermined column for only the rows satisfying the conditions in the data frame, and the upper part of the drawing illustrates a Python program example using a cuDF similarly to the example of FIG. 5 described above. Furthermore, an example of loaded image of the data frame in the storage of a computer, etc. and in the memory of a GPU is illustrated in the lower part of the drawing.

In FIG. 6, an example is illustrated in which the file to be processed recorded on a storage 10 is a fixed-length file which is often used in batch processing of a legacy system or the like. In the fixed-length file, for example, data of n rows with four columns of “col0” to “col3” is recorded. The data of the fixed-length file is read and loaded as a data frame on a GPU memory as illustrated in a GPU 20a via a process of a CPU which is not illustrated or directly without the CPU process using a direct memory access (DMA) technology when possible.

At this time, in order to effectively perform parallel processing by the GPU, the data is converted into alignment, in which rows and columns are interchanged as illustrated so that the data of each row is arranged in accordance with the data reading direction of the GPU, and loaded onto the GPU memory. As a result, the process of determining whether the conditions are satisfied for each column can be more efficiently performed through parallel processing of the GPU.

Thereafter, condition calculation is performed on the data frame according to the Python program. In the program, a condition (“condition1_func”) for “col0” and a condition (“condition2_func”) for “col1” are set, and as illustrated in a GPU 20b, determination results (“cond1_series”, “cond2_series”) as to whether each row satisfies the respective condition are loaded onto the GPU memory.

Thereafter, the target value is calculated for the data frame according to the Python program. The program is instructed to execute a process (“result_func”) of calculating based on the data in “col2” and “col3” for the rows that satisfy the conditions (true for both “cond1_series” and “cond2_series”), and as illustrated in a GPU 20c, the calculation results (“result”) are loaded into the data frame only for the rows that satisfy the conditions.

Thus, by performing the pre-processing of loading all the necessary data as the data frame on the GPU memory by merging or the like, specifying the row satisfying the conditions for each column, and filtering only the target row to calculate collectively through parallel processing of the GPU, the processing can be greatly sped up. Note that these processes can be implemented by, for example, a Python program using a cuDF or the like (the same applies to other processes described in the present embodiment).

### Data Extraction Processing by Inequality Sign or the Like

As a method in which it is difficult to increase the speed by parallel processing in addition to the IF branch in the processing of the data frame, there is a method in which data belonging to a predetermined range is extracted and set as a processing target, such as condition designation by a BETWEEN operator or an inequality sign in COBOL. For example, there is a case where the consumption tax rate applied when calculating a transaction fee related to an order in a financial institution varies depending on the year of transaction.

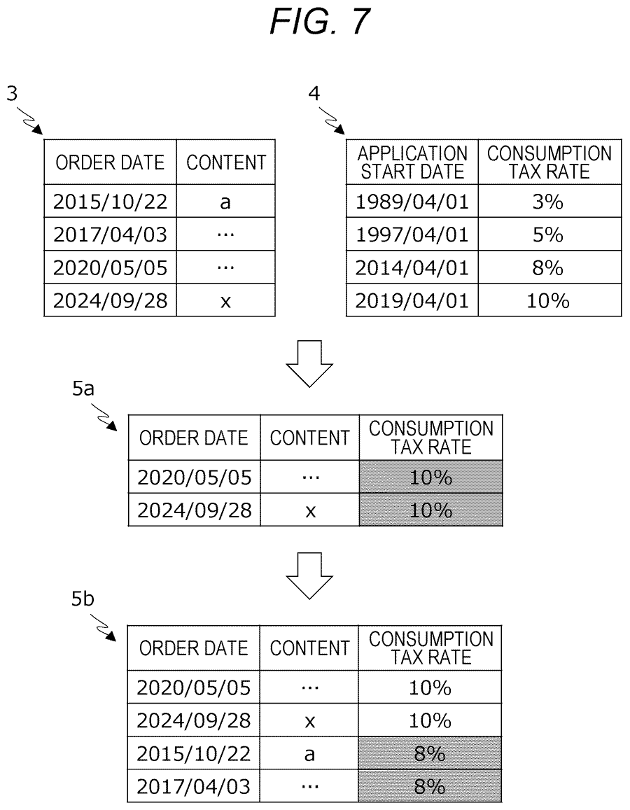

FIG. 7 is a diagram illustrating an outline of another example of data frame processing according to one embodiment of the present invention. In the upper part of the drawing, an order data frame 3 and a consumption tax data frame 4 are illustrated. The order data frame 3 retains order dates and contents thereof for a plurality of orders, and the consumption tax data frame 4 retains a consumption tax rate for each year (applicable period) specified by an application start date.

In acquiring the consumption tax rate applied to each order of the order data frame 3, according to the example of FIG. 7, for each record of the consumption tax rate in the consumption tax data frame 4, conditional branch processing is performed on whether the order date of each order of the order data frame 3 belongs to the applicable period of the consumption tax rate of the target, and the record contents of the orders whose order dates belong to the applicable period are merged.

A data frame 5a in the drawing indicates that, for a record with a consumption tax rate of 10% in the consumption tax data frame 4, a record is created by extracting order data on and after Apr. 1, 2019, which is the application start date, from the order data frame 3 and merging the order data. Further, a data frame 5b indicates that, for a record with a consumption tax rate of 8%, a record is created by extracting order data on and after Apr. 1, 2014 (and before Apr. 1, 2019), which is the application start date, from the order data frame 3 and merging the order data.

By creating the data frames 5a and 5b to reconstruct the data frame using such a method, it is possible to acquire the consumption tax rate applied to the order date of each order. While this method provides a simple and easy-to-understand implementation, it requires loop processing for each record in the order data frame 3 and the consumption tax data frame 4, resulting in increased processing time.

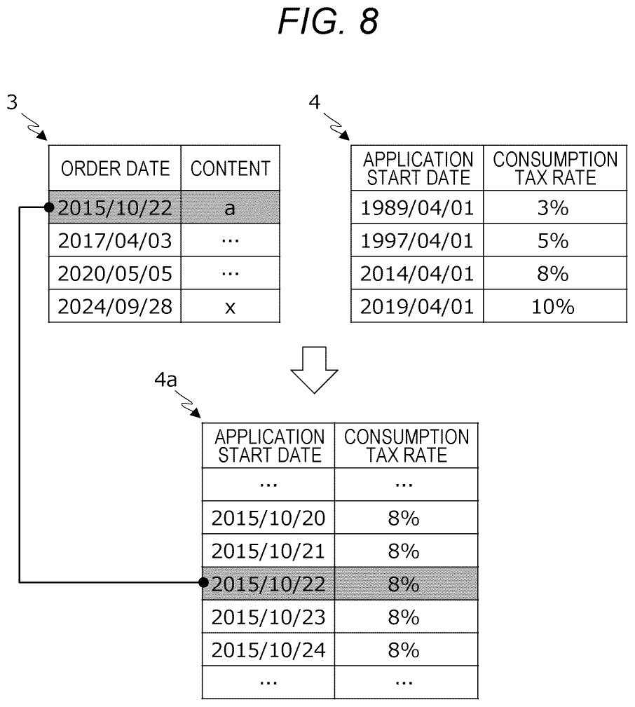

FIG. 8 is a diagram illustrating an outline of another example of data frame processing according to one embodiment of the present invention. Here, for the order data frame 3 and the consumption tax data frame 4 similar to the example of FIG. 7 described above, the application start dates of the respective consumption tax rates of the consumption tax data frame 4 are all loaded on a daily basis to form a consumption tax data frame 4a, and then records with matching dates (the loaded application start dates and order dates) between the consumption tax data frame 4a and the order data frame 3 are combined to reconstruct the data frame.

In the example of FIG. 8, since the record of Oct. 22, 2015 among the application start dates loaded in the consumption tax data frame 4a matches the order date of the order data frame 3, 8% can be obtained as the consumption tax rate applied to the order by combining these records. This method is suitable for the processing in the GPU because the load and the combination processing of the data frame are performed, and thus can increase the speed and efficiency. However, since the records corresponding to the date are required when the consumption tax data frame 4a is loaded, the memory consumption amount on the GPU may greatly increase.

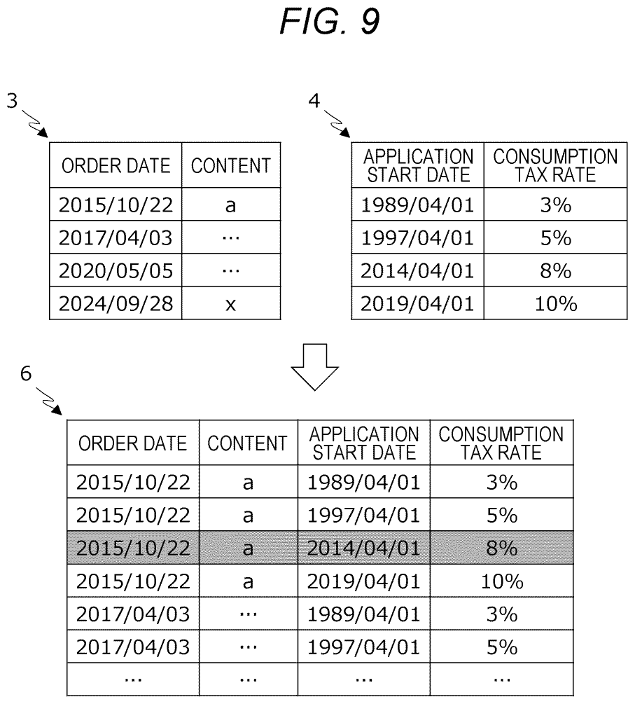

FIG. 9 is a diagram illustrating an outline of another example of data frame processing according to one embodiment of the present invention. Here, for the order data frame 3 and the consumption tax data frame 4 similar to the example of FIG. 7 described above, these data frames are cross-combined and reconstructed, and only the records satisfying the conditions are extracted.

In the example of FIG. 9, for each record of the order data frame 3, each corresponding record of the consumption tax data frame 4 is merged to form a data frame 6, and then a record satisfying the condition that the order date belongs to the year specified by the application start date (in the example of FIG. 9, a record in which the order date is Oct. 22, 2015 and the consumption tax rate is 8%) is extracted. This method is suitable for the processing in the GPU because the combination processing of the data frame and the filter processing of extracting only the records satisfying the conditions are performed, and thus can increase the speed and efficiency. However, since the total number of records of the data frame 6 obtained by combining is the number obtained by multiplying the number of records of each of the order data frame 3 and the consumption tax data frame 4, the memory consumption amount on the GPU may greatly increase.

Thus, since the data frame processing method illustrated in the examples of FIGS. 7 to 9 has advantages/disadvantages, it is desirable to appropriately select a method according to the amount of data to be processed and other characteristics. Although the acquisition of the consumption tax rate applied to the order has been illustrated as an example in the examples of FIGS. 7 to 9, it is needless to say that the present invention can be widely and flexibly applied to other targets and cases without being limited to such targets and cases.

### When There are Constraints Such as Dependency and Processing Order Between Records

In data frame processing, another method of processing that is difficult to accelerate through parallel processing is the case where there is inter-record dependency within a data frame or across data frames, or where constraints exist with respect to the processing order. For example, in a securities transaction, when a plurality of cancellation orders are made for a predetermined brand in an account, the number of stocks deposited is insufficient with respect to the total cancellation quantity, and thus the cancellation quantity needs to be adjusted.

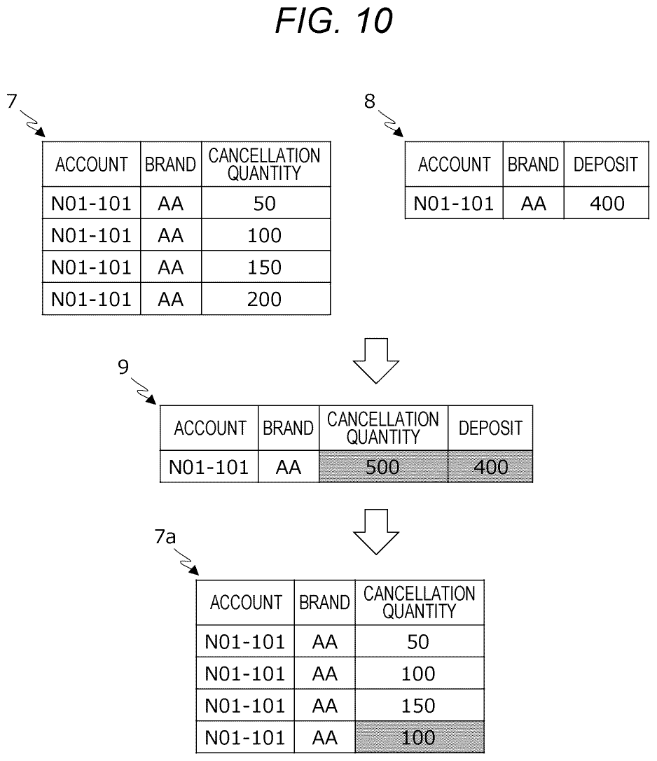

FIG. 10 is a diagram illustrating an outline of another example of data frame processing according to one embodiment of the present invention. Here, an example is illustrated in which the actual deposit amount of the account/brand retained in a deposit data frame 8 is insufficient (that is, there is inter-record dependency, and there is a constraint by the deposit data frame 8 when an order data frame 7 is processed) when all cancellation orders related to the target account/brand in the order data frame 7 in the drawing are processed. For example, in the case where a cancellation order is specified by amount rather than by quantity, the quantity to be canceled cannot be specified, and thus, such a situation may arise. In this case, for example, it is necessary to reduce the cancellation quantity related to the latest and recent orders so that the total cancellation quantity is equal to or less than the deposit amount.

In the example of FIG. 10, the order data frame 7 is in a state in which the cancellation quantity has already been calculated from the amount of cancellation. The cancellation quantity of each record is aggregated and summed in units of account/brand, and records of the deposit amounts of the target account/brand in the deposit data frame 8 are merged for comparison (data frame 9). In the example of the drawing, it can be seen that the total cancellation quantity is 500, whereas the actual deposit amount is only 400, revealing a shortfall of 100.

Based on this comparison result, the shortfall is corrected by subtracting the difference from the cancellation quantity of the latest (most recent) record in the order data frame 7 (data frame 7a), and then, the total cancellation quantity is calculated and compared with the deposit amount again. Thus, when there is dependency or constraint between records in data frames, it is possible to execute the processing as data frame processing on the GPU by performing preprocessing that creates an intermediate processing data frame which is used to determine whether the dependency or constraint applies by aggregating, processing, etc. one or both of the data frames and merging them, etc., so that the comparison and processing related to the dependency or constraint can be performed.

As described above, according to the data processing method according to one embodiment of the present invention, it is possible to speed up the processing by performing preprocessing of loading all pieces of data necessary as data frames onto the GPU memory by, for example, merging, and processing and reconstructing the data frames so that it is possible or suitable to process the data frames collectively by parallel calculation on the GPU.

Although the invention made by the present inventors has been specifically described on the basis of the embodiments, the present invention is not limited to the embodiments described above, and it goes without saying that various modifications may be made without departing from the gist of the present invention. The embodiments above have been described in detail to explain the present invention in an easy-to-understand manner, and the present invention is not necessarily limited to the embodiments including all the components described. Furthermore, it is possible to add, delete, or replace other components for part of the configuration in the above-described embodiment.

Some or all of the components, functions, processing units, processing procedures, and the like described above each may be implemented by hardware being designed as an integrated circuit, for example. Alternatively, the components, functions, and the like described above may be implemented by software by a processor interpreting and executing programs for implementing the individual functions. Information such as programs, tables, and files for implementing each function may be stored in a recording device such as a memory, a hard disk, or an SSD, or in a recording medium such as an integrated circuit (IC) card, a secure digital (SD) card, or a digital versatile disc (DVD).

Each of the drawings mentioned above illustrates control lines and information lines considered to be necessary for the description and does not necessarily illustrate all the control lines and information lines supposed to be carried out. It may be considered that almost all the components are mutually connected in practice.

### INDUSTRIAL APPLICABILITY

The present invention is applicable to a data processing method and a data processing program for performing data processing by a GPU.

What is claimed is:

1. A data processing method for processing a data in a data frame format by a computer including a graphics processing unit (GPU), the data processing method causing the computer to execute:
a first step of reading all or a part of a data to be processed and loading the data into a data frame on a memory of the GPU;
a second step of merging a second data which is necessary for processing a first data loaded in the data frame into the data frame;
a third step of determining whether a condition for executing a predetermined process is satisfied for each column of the data frame; and
a fourth step of extracting a row in which a value of each column satisfies the condition in the data frame, executing the predetermined process on each row, which has been extracted, through parallel processing of the GPU, and recording a processing result in the each row.

2. The data processing method according to claim 1, wherein
in the second step, when each row of the second data is determined for each range of value of a predetermined column of the first data, the each row of the second data and a row of the first data to which a value of the predetermined column belongs in a range of the each row of the second data are merged to obtain the data frame.

3. The data processing method according to claim 1, wherein
in the second step, when each row of the second data is determined for each range of value of a predetermined column of the first data, all values of the each range of the second data are loaded in units of rows, and each row which has been loaded and a row matching a value of the predetermined column of the first data are combined to obtain the data frame.

4. The data processing method according to claim 1, wherein
in the second step, each row of the first data is multiplied by each row of the second data to obtain the data frame.

5. The data processing method according to claim 1, wherein
in the second step, when there is a constraint by the second data in processing the first data, a data frame for determining whether the constraint applies is created based on the first data and/or the second data, and when it is determined that the constraint applies based on the data frame, content of the first data is corrected based on this determination result to obtain the data frame.

6. The data processing method according to claim 1, wherein
in the first step, for each column of the data to be processed, the data is loaded in the data frame in a manner that a value of each row related to the each column is arranged in a reading direction of a memory of the GPU.

7. A data processing program for causing a computer including a graphics processing unit (GPU) to process a data in a data frame format, the data processing program causing the computer to execute:
a first step of reading all or a part of a data to be processed and loading the data into a data frame on a memory of the GPU;
a second step of merging a second data which is necessary for processing a first data loaded in the data frame into the data frame;
a third step of determining whether a condition for executing a predetermined process is satisfied for each column of the data frame; and
a fourth step of extracting a row in which a value of each column satisfies the condition in the data frame, executing the predetermined process on each row, which has been extracted, through parallel processing of the GPU, and recording a processing result in the each row.
